(19) United States
(12) Patent Application Publication
(10) Pub. No.: US 2022/0095661 A1
(43) Pub. Date: Mar. 31, 2022

(54) COMPOSITION FOR MAINTAINING OR IMPROVING THE QUALITY OF PROCESSED MEAT

(71) Applicant: Purac Biochem B.V., Gorinchem (NL)

(72) Inventors: Gerrit Anthon Rene HILHORST, Gorinchem (NL); Saffiera KARLEEN, Gorinchem (NL); Lonneke VAN DIJK, Gorinchem (NL); Liya YI, Gorinchem (NL); Stephan Hubertus Johannes Mathias DOBBELSTEIN, Gorinchem (NL)

(21) Appl. No.: 17/539,935

(22) Filed: Dec. 1, 2021

Related U.S. Application Data
(63) Continuation of application No. PCT/EP2020/065700, filed on Jun. 5, 2020.

(30) Foreign Application Priority Data
Jun. 5, 2019 (EP) 19178474.3

(51) Int. Cl. A23L 27/00; A23J 3/12; A23L 33/15

(52) U.S. Cl. CPC A23L 27/82; A23L 33/15; A23J 3/12

(57) ABSTRACT

The invention relates to a composition for maintaining or improving the quality of processed meat, said composition comprising on a dry matter basis:
between 20 and 60% w/w acid equivalent of an organic acid component selected from the group of acetate, lactate and combinations thereof;
between 0.02 and 2% w/w acid equivalent of glutamate; and
between 5 and 50% w/w of a vegetal fiber selected from the group of microfibrillated cellulose fiber, inulin and combinations thereof
   wherein the composition when diluted with distilled water of 20° C. to a dry matter content of 10% w/w has a pH in the range of 5.0 to 9.0.

This composition can replace conventional stabilizers, acid regulators and anti-oxidants without deteriorating the quality of the processed meat. Furthermore, this composition can be composed of vegetal ingredients, with a more attractive consumer perception.

The invention also relates to a method for the preparation of the aforementioned meat treatment composition.

### CROSS-REFERENCE TO RELATED APPLICATIONS

The present application is a Continuation of International Patent Application No. PCT/EP2020/065700, filed Jun. 5, 2020, which claims priority to European Patent Application No. 19178474.3 filed Jun. 5, 2019; the entire contents of all of which are hereby incorporated by reference.

### TECHNICAL FIELD OF THE INVENTION

The invention relates to compositions for maintaining or improving the quality of processed meat comprising (i) an organic acid component selected from the group of acetate, lactate and combinations thereof, (ii) glutamate and (iii) vegetal fiber. The invention further relates to a method for the preparation of these compositions and a process of preparing processed meat.

### BACKGROUND OF THE INVENTION

Processed meat is meat that has been subjected to modification in order to improve its taste and/or to extend its shelf life. Processing methods include e.g. grinding, salting, curing, fermentation and smoking. Examples of processed meat products are bacon, ham, sausages, salami, corned beef, beef jerky, canned meat and meat-based sauces.

In order to attain processed meat with the desired properties, various additional ingredients are commonly used. These additives may contribute to the shelf life, both microbiologically and chemically, the texture, flavor and color of the product and to the yield of the method of preparation. Conventional additives are e.g. salts, phosphates, benzoates, sorbates, acids, nitrate or nitrite, caseinate. Such additives may be disliked by consumers because they are perceived as “chemical” or “artificial” or the like. There is a need for additives that are perceived as more “natural” or “responsible” or “recognizable”.

Attempts to replace these “chemical” additives by more attractive, “label friendly” additives are often hampered due to the complexity of the functional effects of the former additives. Phosphates for instance are known to affect not only the pH stability but also the protein extraction from the meat, the water-holding capacity and the hydration of the meat. Nitrate and nitrite are known to affect not only the color and the flavor of the meat but also have an antimicrobial effect. Since there generally also is a complex interplay between the different additives in their effects, it has turned out to be difficult to find alternatives for conventional “chemical” additives.

EP3106041A1 describes meat treatment compositions comprising one or more acetic acid salts and one or more polysaccharide materials which are particularly effective in reducing moisture loss during cooking of meat. Since in some embodiments of these compositions, the ingredients can be based on natural vinegar and plant derived fiber materials, these compositions may also be attractive from the perspective of “label friendly” additives.

CN107811214A describes sausages containing inulin and monosodium glutamate.

WO2019006355A1 relates to dry mixtures for preserving color of a meat product, said dry mixtures comprising dried lemon and dried vinegar.

BE1020864A3 describes a meat treatment composition comprising a powder mixture of (i) lactate/acetate and (ii) starch and/or vegetable fiber. The vegetable fiber may be wheat bran, oat bran, pea fibre, and fibre from bamboo or carrots.

US2011028550A1 relates to antimicrobial preservative compositions comprising lactic acid or a salt thereof, acetic acid or a salt thereof, and propionic acid or a salt thereof.

US2006088651A1 describes the preparation of protein fortified meat using a brine that comprises a vegetable protein material, a dairy whey protein material and a curing material.

US2012171330A1 relates to cured meats products containing elevated levels of folic acid.

U.S. Pat. No. 6,890,574B1 describes a taste enhancer for savory food and beverage compositions comprising clear tomato concentrate.

It is the objective of the invention to find additive compositions for processed meat that have multiple functionalities and that are considered more attractive to consumers than conventional additives.

### SUMMARY OF THE INVENTION

The inventors have developed a composition for maintaining or improving the quality of processed meat that has multiple functionalities and that can be based on “label friendly” vegetal ingredients.

The present composition for maintaining or improving the quality of processed meat comprises on a dry matter basis:
between 20 and 60% w/w acid equivalent of an organic acid component selected from the group of acetate, lactate and combinations thereof;
between 0.02 and 2% w/w acid equivalent of glutamate; and
between 5 and 50% w/w of a vegetal fiber selected from the group of microfibrillated cellulose fiber, inulin and combinations thereof
wherein the composition when diluted with distilled water of 20° C. to a dry matter content of 10% w/w has a pH in the range of 5.0 to 9.0.

It was found that this combination of ingredients can replace conventional stabilizers, acid regulators and anti-oxidants without deteriorating the quality of the processed meat.

Furthermore, this composition can be composed of vegetal ingredients, with a more attractive consumer perception.

The invention also relates to a method for the preparation of a composition for maintaining or improving the quality of processed meat, the method comprising
providing an organic acid product selected from the group of a vinegar product, a lactic acid fermentation product and combinations thereof, containing on a dry weight basis at least 50% w/w acid equivalent of acetate and/or lactate, wherein the acetate is elected from sodium acetate, potassium acetate, calcium acetate, acetic acid and combinations thereof and wherein the lactate is selected from sodium lactate, potassium lactate, calcium lactate, lactic acid and combinations thereof,
providing a tomato extract containing on a dry weight basis at least 1.0% w/w acid equivalent of glutamate, wherein the glutamate is present as a component selected from sodium glutamate, potassium glutamate, glutamic acid and combinations thereof
providing a vegetal fiber selected from the group of citrus fiber and inulin;
mixing the organic acid product, the tomato extract and the vegetal fiber to prepare a composition with a dry matter content of at least 30% w/w, preferably at least 50% w/w.

The invention also relates to a process of preparing processed meat, said process comprising adding the composition according to the invention to processed meat in an amount of between 0.5 and 15% w/w dry matter.

### DESCRIPTION OF THE DRAWINGS

FIG. 1 displays evaluation results of flavour and texture of the Product 3 and Product 6 versus a phosphate containing Reference. Differences between the two products are shown for attributes of meatiness, saltiness, sourness, sweetness, juiciness and compactness on a scale of 0-10.

FIG. 2 displays results of a shelf life challenge study between a control meat product, Product 2 and Product 5 with Listeria monocytogenes at 4° C.

FIG. 3 displays results of a shelf life challenge study between a control meat product, Product 2 and Product 5 with Carnobacteria at 4° C.

### DETAILED DESCRIPTION OF THE INVENTION

Accordingly, a first aspect of the invention relates to a composition for maintaining or improving the quality of processed meat comprising on a dry matter basis:
between 20 and 60% w/w acid equivalent of an organic acid component selected from the group of acetate, lactate and combinations thereof;
between 0.02 and 2% w/w acid equivalent of glutamate; and
between 5 and 50% w/w of a vegetal fiber selected from the group of microfibrillated cellulose fiber (MCF), inulin and combinations thereof
wherein the composition when diluted with distilled water of 20° C. to a dry matter content of 10% w/w has a pH in the range of 5.0 to 9.0.

The term “acetate” as used herein, unless indicated otherwise, encompasses acetic acid, salts of acetic acid, dissociated acetate and combinations thereof.

The term “lactate” as used herein, unless indicated otherwise, encompasses lactic acid, salts of lactic acid, dissociated lactate and combinations thereof.

The term “propionate” as used herein, unless indicated otherwise, encompasses propionic acid, salts of propionic acid, dissociated propionate and combinations thereof.

The concentration of acetate expressed as “% w/w acid equivalent” refers to the total concentration of acetate assuming that all acetate is present as acetic acid.

The concentration of lactate expressed as “% w/w acid equivalent” refers to the total concentration of lactate assuming that all lactate is present as lactic acid.

The concentration of propionate expressed as “% w/w acid equivalent” refers to the total concentration of propionate assuming that all propionate is present as propionic acid.

The term “glutamate” as used herein, unless indicated otherwise, encompasses glutamic acid, salts of glutamic acid, dissociated glutamate and combinations thereof.

The concentration of glutamate expressed as “% w/w acid equivalent” refers to the total concentration of glutamate assuming that all glutamate is present as glutamic acid.

The term “ascorbate” as used herein, unless indicated otherwise, encompasses ascorbic acid, salts of ascorbic acid, dissociated ascorbate and combinations thereof. The term “ascorbate” further encompasses iso-ascorbic acid (erythorbic acid), salts of iso-ascorbic acid, dissociated iso-ascorbate and combinations thereof.

The concentration of ascorbate expressed as “% w/w acid equivalent” refers to the total concentration of ascorbate assuming that all ascorbate is present as ascorbic acid.

The term “microfibrillated cellulose fiber” or “MCF”, as used herein, unless indicated otherwise, refers to water-insoluble cellulose microfibrils, more particularly to water-insoluble cellulose microfibrils having a length L and a mean diameter D, wherein the ratio L/D is at least 30 and D is in the range of 1-50 nm. These cellulose microfibrils are no longer meshed into a cell wall polysaccharide matrix as a result of a defibrillation treatment, e.g. high pressure homogenization.

The term “diameter” as used herein in relation to particle, unless indicated otherwise, refers to the average equivalent spherical diameter of said particle. Likewise, unless indicated otherwise, the term “diameter” as used herein in relation to a microfibril, refers to the average diameter of said microfibril.

In another embodiment, the invention relates to a composition for maintaining or improving the quality of processed meat, comprising on a dry matter basis:
between 20 and 60% w/w acid equivalent of an organic acid component selected from the group of acetate, lactate, propionate and combinations thereof;
between 0.02 and 2% w/w acid equivalent of glutamate; and
between 5 and 50% w/w of a vegetal fiber selected from the group of microfibrillated cellulose fiber (MCF), inulin and combinations thereof
wherein the composition when diluted with distilled water of 20° C. to a dry matter content of 10% w/w has a pH in the range of 5.0 to 9.0.

The composition can be a powder having a water content of less than 15% w/w or an aqueous liquid having a dry matter content of 10 to 80% w/w.

If the composition is a powder, the acetate is preferably selected from sodium acetate, potassium acetate, calcium acetate, acetic acid and combinations thereof. Similarly, the lactate is preferably selected from sodium lactate, potassium lactate, calcium lactate, lactic acid and combinations thereof, and the propionate is preferably selected from sodium propionate, potassium propionate, calcium propionate, propionic acid and combinations thereof. The glutamate is preferably selected from sodium glutamate, potassium glutamate, glutamic acid and combinations thereof.

In a preferred embodiment, the composition is a powder having a water content of less than 15% w/w; wherein the acetate, if present, is selected from sodium acetate, potassium acetate, calcium acetate, acetic acid and combinations thereof; wherein the lactate, if present, is selected from sodium lactate, potassium lactate, calcium lactate, lactic acid and combinations thereof; wherein the propionate, if present, is selected from sodium propionate, potassium propionate, calcium propionate, propionic acid and combinations thereof and wherein the glutamate, if present, is selected from sodium glutamate, potassium glutamate, glutamic acid and combinations thereof. More preferably, the water content of the powder is less than 10% w/w, even more preferably less than 7% w/w.

In a preferred embodiment, the acetate is present as sodium acetate. In yet another preferred embodiment, the lactate is present as sodium lactate. In yet another preferred embodiment, the propionate is present as sodium propionate. In yet another preferred embodiment, the glutamate is present as sodium glutamate.

According to another preferred embodiment, the composition is an aqueous liquid having a dry matter content of 10 to 80% w/w. More preferably, the dry matter content of the aqueous liquid is between 20 and 75% w/w, even more preferably between 30 and 70% w/w.

In the composition in liquid form, the acetate is preferably selected from acetate (in its dissociated form), acetic acid and combinations thereof. The lactate is preferably selected from lactate (in its dissociated form), lactic acid and combinations thereof. The propionate is preferably selected from propionate (in its dissociated form), propionic acid and combinations thereof. The glutamate is preferably selected from glutamate (in its dissociated form), glutamic acid and combinations thereof.

In a preferred embodiment of the invention, the composition comprises on a dry matter basis between 25 and 55% w/w, more preferably between 30 and 50% w/w, acid equivalent of the organic acid component selected from the group of acetate, lactate and combinations thereof.

In another preferred embodiment of the invention, the composition comprises on a dry matter basis between 25 and 55% w/w, more preferably between 30 and 50% w/w, acid equivalent of the organic acid component selected from the group of acetate, lactate, propionate and combinations thereof.

The acetate in the composition is preferably derived from neutralized vinegar. Vinegar can be generally defined as an aqueous solution of acetic acid that additionally contains small quantities of components that are produced during fermentation, e.g. by acetic acid bacteria.

Vinegar is preferably obtained by fermentation of a dilute ethanol-containing substrate, preferably using acetic acid bacteria. This ethanol-containing substrate is preferably obtained by yeast fermentation of a vegetal product. The vinegar may be selected from the group consisting of white vinegar, brandy vinegar, alcoholic vinegar, balsamic vinegar, wine vinegar, malt vinegar, beer vinegar, potato vinegar, rice vinegar, apple vinegar, cherry vinegar, and cane vinegar. In a particularly preferred embodiment of the invention, the vinegar is cane vinegar.

In another preferred embodiment of the invention, the acetate content of the neutralized vinegar is at least 5% (w/w), more preferably at least 7.5% (w/w/, even more preferably at least 10% (w/w). It is also possible to make use of neutralized vinegar that has been pre-concentrated to a certain extent. Such products are commercially available and typically have an acetate content between 20 and 30% (w/w). In a preferred embodiment of the invention, the acetate content is at least 20% (w/w), more preferably at least 25% (w/w), e.g. about 29 or 30% (w/w).

Neutralized vinegar may be produced by adding an alkalizing agent to vinegar, preferably an alkalizing metal salt, such as a metal carbonate or a metal hydroxide. The metal hydroxide is preferably selected from sodium hydroxide, potassium hydroxide, calcium hydroxide and combinations thereof. Most preferably, the metal hydroxide is sodium hydroxide.

The neutralized vinegar may be concentrated by water removal, eg by evaporation, and/or dried, eg by spray drying.

Preferably, the neutralized vinegar when diluted with distilled water of 20° C. to a dry matter content of 10% w/w preferably has a pH of at least 6, more preferably of at least 7, even more preferably of at least 7.5, most preferably of at least 8.0.

In accordance with an embodiment of the invention, the neutralized vinegar is provided in the form of a free flowing powder. The production of free flowing powders from liquid neutralized vinegars, using conventional drying techniques such as spray drying, has been described in the art. For example, international patent application no. WO/2014/021719, the disclosure of which is hereby incorporated by reference in its entirety, describes processes of producing free flowing powders from alkalized vinegar. Additionally, neutralized vinegars in free flowing powder form are commercially available.

The lactate is preferably provided in the form of a lactic acid fermentation product. The fermentation process for the production of lactate is generally carried out by fermentation of a sugar-containing medium with micro-organisms capable of transforming the sugar into lactic acid. Such micro-organisms are well-known to the person skilled in the art and include lactic acid bacteria. Sugars that can be used generally are C₆ sugars in both monosaccharide and disaccharide form such as glucose, saccharose and lactose. Preferably, saccharose from cane, corn or beet is used. The fermentation can generally be carried out with or without pH control. Without pH control, the pH will decrease with ongoing fermentation due to the production of lactic acid. With pH control, alkalizing agents are added to the fermentation broth in order to maintain the pH at a desired level such as a neutral or near-neutral pH. Alkalizing agents that are typically used are sodium hydroxide, potassium hydroxide, calcium hydroxide etcetera. After fermentation, the lactic acid fermentation product is usually further processed by means of downstream processes such as centrifugation, filtration, membrane filtration, distillation, extraction, evaporation and drying in order to purify and concentrate the product.

Preferably, the lactate is a neutralized lactic acid fermentation product that is obtained by means of lactic acid fermentation and addition of an alkalizing agent. The alkalizing agent preferably is an alkalizing metal salt, such as a metal carbonate or a metal hydroxide. More preferably, the metal hydroxide may be sodium hydroxide, potassium hydroxide or calcium hydroxide. Most preferably, the metal hydroxide is sodium hydroxide.

The neutralized lactic acid fermentation product may be concentrated by water removal, eg by evaporation, and/or dried, eg by spray drying.

The neutralized lactic acid fermentation when diluted with distilled water of 20° C. to a dry matter content of 10% w/w preferably has a pH of at least 6, more preferably of at least 7, even more preferably of at least 7.5, most preferably of at least 8.0.

In accordance with an embodiment of the invention, the neutralized lactic acid fermentation product is provided in the form of a free flowing powder. The production of free flowing powders from liquid neutralized lactic acid fermentation products, using conventional drying techniques such as spray drying, has been described in the art. For example, European patent no. EP2879524B1, the disclosure of which is hereby incorporated by reference in its entirety, describes processes of producing free flowing powders from neutralized lactic acid fermentation products containing both Na and Ca. Additionally, neutralized lactic acid fermentation products in free flowing powder form are commercially available.

The propionate is preferably derived from a propionic acid fermentation product. The fermentation process for the production of propionate is generally carried out by fermentation of either a sugar-containing medium or a lactic acid containing medium with micro-organisms capable of transforming the substrate into propionic acid. Such micro-organisms are well-known to the person skilled in the art and include propionibacteria. Sugars that can be used generally are C₆ sugars in both monosaccharide and disaccharide form such as glucose, saccharose and lactose. Preferably, saccharose from cane, corn or beet is used. The fermentation can generally be carried out with or without pH control. Without pH control, the pH may decrease with ongoing fermentation due to the production of lactic acid. With pH control, alkalizing agents are added to the fermentation broth in order to maintain the pH at a desired level such as a neutral or near-neutral pH. Alkalizing agents that are typically used are sodium hydroxide, potassium hydroxide, calcium hydroxide etcetera. After fermentation, the propionic acid fermentation product is usually further processed by means of downstream processes such as centrifugation, filtration, membrane filtration, distillation, extraction, evaporation and drying in order to purify and concentrate the product.

Preferably, the propionate is obtained by means of propionic acid fermentation and preferably an alkalizing agent is added to the propionic acid fermentation product so obtained. The alkalizing agent preferably is an alkalizing metal salt, such as a metal carbonate or a metal hydroxide. More preferably, the metal hydroxide may be sodium hydroxide, potassium hydroxide or calcium hydroxide. Most preferably, the metal hydroxide is sodium hydroxide.

Before or after neutralization, the propionic acid fermentation product may suitably be concentrated by water removal, eg by evaporation, and/or dried, eg by spray drying.

The neutralized propionic acid fermentation product when diluted with distilled water of 20° C. to a dry matter content of 10% w/w preferably has a pH of at least 6, more preferably of at least 7, even more preferably of at least 7.5, most preferably of at least 8.0.

In accordance with an embodiment of the invention, the neutralized propionic acid fermentation product is provided in the form of a free flowing powder. The production of free flowing powders from liquid propionic acid fermentation products, using conventional drying techniques such as spray drying, has been described in the art. Additionally, propionic acid fermentation products in free flowing powder form are commercially available.

Glutamate is known as a taste enhancer in food, providing an “umami” taste. Whereas it is often added in the form of pure monosodium glutamate, glutamate can also be added in the form of a glutamate-rich product such as yeast extract or sea weed. Next to that, glutamate-rich products can also be obtained by hydrolyzing glutamate-rich vegetable proteins. Examples of vegetable proteins that can be used as a source of glutamate include, for instance, tomato, corn, soy and rapeseed.

In an embodiment of the present invention, the composition comprises on a dry matter basis between 0.04 and 1.5% w/w, more preferably between 0.06 and 1% w/w, acid equivalent of glutamate.

In a preferred embodiment of the invention, the glutamate is provided by a tomato extract, preferably by a clear tomato serum concentrate as described in U.S. Pat. No. 6,890,57481, the disclosure of which is hereby incorporated by reference in its entirety. The tomato extract is preferably obtained by hydrolyzing the tomato protein that is contained in tomato serum, optionally followed by a concentration step. Tomato serum can be obtained by separating the pulp fraction from tomato juice. The protein hydrolysis may be carried out by acid hydrolysis or enzymatic hydrolysis. Next to glutamate, the tomato extract typically contains other amino acids such as aspartic acid, threonine, serine, asparagine, glutamine, alanine, phenylalanine, gamma aminobutyric, lysine and histidine.

The tomato extract preferably contains between 0.5 and 20% w/w free amino acids. The glutamate content of the tomato extract preferably is between 10 and 50% w/w of the total amount of free amino acids.

In yet another embodiment, the glutamate is provided by a vegetal isolate obtained from a vegetal selected from the group of mushroom, wheat, soy, seaweed and groundnut.

Vegetal fibers can be of interest as “label friendly” ingredients in meat products because of their potential contribution to minimizing moisture loss during cooking of the meat products and to improving quality attributes of meat products such as juiciness and tenderness. The inventors have found that it is particularly advantageous to make use of vegetal fiber selected from the group of microfibrillated cellulose fiber (MCF), inulin and combinations thereof in the compositions according to the invention.

In an embodiment of the invention, the composition comprises on a dry matter basis between 7 and 45% w/w, preferably between 8 and 42% w/w, of the vegetal fiber selected from the group of microfibrillated cellulose fiber, inulin and combinations thereof.

The MCF employed in accordance with the present invention preferably originates from parenchymal tissue from fruits, roots, bulbs, tubers, stalks, seeds or combination thereof. More preferably, the MFC originates from fruits.

Examples of suitable sources for MFC includes citrus fruit, tomato fruit, peach fruit, pumpkin fruit, kiwi fruit, apple fruit, mango fruit, sugar beet, sugar cane, beet root, turnip, parsnip, maize, oat, wheat, peas, psyllium, bamboo, onion or combinations thereof. Even more preferably, the MFC originates from citrus fruit, tomato fruit, sugar cane, sugar beet or a combination thereof. Preferably, the MFC originates from citrus fruit, sugar beet or a combination thereof, most preferably the MFC originates from citrus fruit.

The MFC in the composition according to the invention is typically produced from parenchymal material that besides cellulose contains hemicellulose and pectin. Preferably, the composition according to the invention contains hemicellulose and pectin from the same source(s) as the MFC. More preferably, the composition according to the invention contains a weight ratio of hemicellulose and pectin to MFC of between 0 and 1.3, more preferably of between 0.05 and 1.0, most preferably of between 0.1 and 0.7.

The MFC is obtainable from the aforementioned sources by processes generally known by those skilled in the art. WO 2006/033697, the disclosure of which is hereby incorporated by reference in its entirety, describes exemplary processes for producing the plant fiber materials suitable for use in the present invention. Such processes typically entail a high pressure homogenization step or other process steps in which high shear conditions are applied, in order to obtain the MFC with the properties as described herein.

It is known to those skilled in the art that treatment of the plant pulp with chemicals (e.g. acids and/or bases), enzymes (e.g. pectinase, protease, cellulase, hemicellulase or mixtures thereof) and/or heat, affects the solubilization and extraction of certain plant cell wall components, in particular pectin and hemicelluloses. This may be used to tailor the specific properties of the fiber material, especially the water binding capacity and/or viscosifying properties.

Particularly suitable MFC containing materials are commercially available from suppliers like J. Rettenmaier and Sohne GMBH under the Vitacel brand/name; Herbafood Ingredients under the Herbacel brand/name; and Fiberstar under the Citri-Fi brand/name.

The MFC that is contained in the food product typically comprises at least 80% w/w of cellulose microfibrils having a length L and a mean diameter D, wherein the ratio LID is at least 10 and D is in the range of 3-70 nm.

The cellulose microfibrils of the MFC typically have a mean diameter smaller than 30 nm, more preferably smaller than 20 nm, most preferably smaller than 15 nm.

The average degree of crystallinity of the MFC typically is less than 40%, more preferably less than 35% and most preferably less than 30%.

Without wishing to be bound by any theory, it is believed that the advantageous effects of MFC are at least in part based on the water-binding capacity of the cellulose microfibrils. In a preferred embodiment of the invention, the MFC exhibits a water binding capacity within the rage of 4-25 g of water per gram MFC, most preferably within the range of 5-20 g of water per gram MFC.

The water binding capacity of MFC can be measured using the following procedure: 2.5 g of the MFC (dry powder) is placed into a 50 ml centrifuge tube and weighed (noted as W1). Then 40 g of milli-Q water (noted as W2) is added. The tube is closed and stirred by hand for one minute. The tube is centrifuged for ten minutes at 2000 rpm, and the supernatant is decanted and weighed (noted as W3). The water binding capacity (WBC) of the MFC is calculated by the following formula: WBC=(W2−W3)/W1. The WBC is expressed as grams of water per gram of MFC (g water/g MFC).

In an alternative embodiment of the invention, the vegetal fiber is inulin. Inulin is a natural dietary fiber material, present in many plants. Chicory root contains a relatively high amount of inulin and is therefore often used as an inulin source. Inulin is a polysaccharide chain of fructose monomers. It is commercially available in various grades of purity and various degrees of polymerization like e.g. under the brand/name of Frutafit from Sensus.

In a preferred embodiment of the invention, the inulin is provided by a highly pure inulin product having a purity of at least 90% inulin on dry matter. In a more preferred embodiment, the purity of the inulin product is at least 95%, even more preferred is a purity of at least 99%.

In another preferred embodiment of the invention, the inulin has an average degree of polymerization of between 5 and 50 monomers, in a more preferred embodiment between 10 and 40, in an even more preferred embodiment between 15 and 35, most preferably between 20 and 30 monomers.

In a preferred embodiment of the invention, the composition also comprises ascorbate. Ascorbate is approved as an antioxidant in food products and may be used to e.g. retard color and lipid oxidation and to enhance curing processes. Next to being an antioxidant, it is also known as a vitamin, namely vitamin C. Ascorbate includes isoascorbate, which is also known as erythorbate.

If the composition is a powder, the ascorbate is preferably selected from sodium ascorbate, potassium ascorbate, calcium ascorbate, ascorbic acid and combinations thereof. In the composition in liquid form, the ascorbate is preferably selected from ascorbate (in its dissociated form), ascorbic acid and combinations thereof.

In a preferred embodiment of the invention, the composition comprises on a dry matter basis between 0.5 and 5% w/w acid equivalent of ascorbate, preferably between 1.0 and 4% w/w acid equivalent of ascorbate.

Ascorbate can be produced by means of chemical synthesis, fermentation or a combination of both techniques, but it can also be retrieved from natural sources such as fruit products. Examples of fruit products with a relatively high ascorbate content are camu camu, seabuckthorn, Indian gooseberry, rose hip, kakadu plum, guava, blackcurrant, orange and lemon. Extracts of these fruits are commercially available as an ascorbate source such as for instance Acerola Cherry 36 from Naturex. In a preferred embodiment of the invention, the ascorbate is provided by a fruit extract. In an even more preferred embodiment, the fruit extract is acerola extract.

In a preferred embodiment of the invention, the composition, when dispersed into distilled water of 20° C. to provide 100 grams of dry matter per L of water, produces an aqueous composition having a pH in the range of 5.5 to 8.5, more preferably in the range of 5.8 to 8.0.

The present composition for maintaining or improving the quality of processed meat can typically be produced by combining various, preferably plant-based, sources of the functional ingredients. A composition in powder form can be obtained by providing the various components in powder form and preparing the composition by means of powder blending. A composition in liquid form can be obtained by providing at least one of the components in liquid form and mixing the other ingredients into the liquid. In a preferred embodiment, the acetate is provided in liquid form. It is also possible to subsequently dry the liquid composition thus obtained, in order to prepare a composition according to the invention in powder form. Drying methods such as spray drying are well known to persons skilled in the art.

According to a second aspect of the invention, a method for the preparation of a composition for maintaining or improving the quality of processed meat as described herein before is provided. The method comprises the steps of:
providing an organic acid product selected from the group of a vinegar product, a lactic acid fermentation product and combinations thereof, containing on a dry weight basis at least 50% w/w acid equivalent of acetate and/or lactate, wherein the acetate is selected from sodium acetate, potassium acetate, calcium acetate, acetic acid and combinations thereof and wherein the lactate is selected from sodium lactate, potassium lactate, calcium lactate, lactic acid and combinations thereof,
providing a tomato extract containing on a dry weight basis at least 1.0% w/w acid equivalent of glutamate, wherein the glutamate is present as a component selected from sodium glutamate, potassium glutamate, glutamic acid and combinations thereof
providing a vegetal fiber selected from the group of citrus fiber and inulin;
mixing the organic acid product, the tomato extract and the vegetal fiber to prepare a composition with a dry matter content of at least 30% w/w, preferably at least 50% w/w.

In another embodiment of the invention, a method for the preparation of a composition for maintaining or improving the quality of processed meat as described herein before is provided. The method comprises the steps of:
providing an organic acid product selected from the group of a vinegar product, a lactic acid fermentation product, a propionic acid fermentation product and combinations thereof, containing on a dry weight basis at least 50% w/w acid equivalent of acetate and/or lactate and/or propionate, wherein the acetate is selected from sodium acetate, potassium acetate, calcium acetate, acetic acid and combinations thereof, wherein the lactate is selected from sodium lactate, potassium lactate, calcium lactate, lactic acid and combinations thereof, and wherein the propionate is selected from sodium propionate, potassium propionate, calcium propionate, propionic acid and combinations thereof,
providing a tomato extract containing on a dry weight basis at least 1.0% w/w acid equivalent of glutamate, wherein the glutamate is present as a component selected from sodium glutamate, potassium glutamate, glutamic acid and combinations thereof
providing a vegetal fiber selected from the group of citrus fiber and inulin;
mixing the organic acid product, the tomato extract and the vegetal fiber to prepare a composition with a dry matter content of at least 30% w/w, preferably at least 50% w/w.

The products used in these preparation methods, i.e. the organic acid product, the tomato extract and the vegetal fiber, have been described in detail herein before.

In a preferred embodiment of the invention, the pH of the composition is adjusted to obtain a value described herein before. If the pH needs to be increased this is preferably done by adding an appropriate amount of an alkali metal hydroxide. If it is desired to lower the pH of the meat treatment composition after combining the various components, this may be suitably done using an appropriate amount of acetic acid, even though the use of mineral acids for this purpose is not excluded.

In another preferred embodiment of the invention, the method comprises the step of mixing the organic acid product, the tomato extract and the vegetable fiber with a fruit extract containing on a dry weight basis at least 10% w/w ascorbate.

Ascorbate may induce unwanted oxygen scavenging in other ingredients of the composition when in powder form. This reaction may be retarded or inhibited by the addition of a filler material to the powder such as silica, maltodextrin, starch. These filler materials are well-known to the person skilled in the art. The amount of filler material preferably is higher than 5% w/w, more preferably higher than 8% w/w, even more preferably higher than 10% w/w, most preferably higher than 12% w/w in the powder.

In a third aspect of the invention, a process for the preparation of processed meat is provided wherein the composition as described herein before is added. The composition may be used in liquid or dry form. If it is used in dry form, it may be reconstituted in a suitable quantity of water, e.g. tap water, before adding it to the meat. To this end, the ingredients are typically agitated for a period of time sufficient to form a homogeneous liquid, which may be a dispersion or solution.

The process for the preparation of processed meat according to the present invention typically comprises the step of adding the composition as described herein before to meat in an amount of between 0.5 and 15% w/w dry matter, preferably between 1.0 and 10% w/w dry matter.

The process according to the present invention is suitable and beneficial for the treatment of most conventional meat products typically offered for human consumption, regardless of the source and/or form in which it is offered.

In a preferred embodiment of the invention, the meat is selected from the group consisting of whole muscle meat, cuts or slices of whole muscle meat, ground or comminuted muscle meat and emulsified meat. In a preferred embodiment of the invention the meat is fresh meat, which may be in the form of whole muscle meat, cuts or slices of whole muscle meat or ground or comminuted muscle meat. In this context the term ‘fresh’ means that the meat has not been treated by cooking in between removal from the animal carcass and the treatment according to the invention. In a preferred embodiment, the meat is uncooked meat.

Preferably, the meat is obtained from beef cattle, pork, lamb, poultry, and game, most preferably from beef cattle, pork, chicken and turkey. In another embodiment of the invention, the meat is red meat.

The process for the preparation of processed meat may utilize any method that is known and/or conventionally used for combining fresh meat and an additive composition. For example, meat may be treated with the composition of the invention by dispersing it throughout the fresh meat. Suitable methods include injecting, pumping, spraying, soaking, dipping or otherwise dispersing the composition into or onto the meat. In addition, the method may comprise tumbling, kneading, massaging or otherwise manipulate the meat to further disperse the composition throughout the meat. In some embodiments, the composition is injected under pressure into the meat as part of an automated commercial meat production step. Suitable injectors may be set to pump a particular volume of the composition into each piece of the meat.

In a preferred embodiment of the invention, the process for the preparation of processed meat comprises adding an aqueous liquid containing the present preservation composition, and wherein the composition is added by injection tumbling.

Once the aqueous liquid has been dispersed throughout the meat, the meat may subsequently be cooked until the desired internal temperature is reached, packaged and refrigerated or frozen. Alternatively, once the aqueous liquid has been dispersed throughout the meat, the meat may be packaged, cooked and then refrigerated or frozen.

The processed meat obtainable by the process for the preparation of processed meat typically has advantageous characteristics with respect to moisture retention, color, texture, flavor and shelf life.

The invention has been described by reference to certain embodiments discussed above. It will be recognized that these embodiments are susceptible to various modifications and alternative forms well known to those of skill in the art. Many modifications in addition to those described above may be made to the structures and techniques described herein without departing from the spirit and scope of the invention. Accordingly, although specific embodiments have been described, these are examples only and are not limiting upon the scope of the invention.

Furthermore, for a proper understanding of this document and in its claims, it is to be understood that the verb “to comprise” and its conjugations used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there be one and only one of the elements. The indefinite article “a” or “an” thus usually means “at least one”.

All patent and literature references cited in the present specification are hereby incorporated by reference in their entirety.

The following examples are offered for illustrative purposes only, and are not intended to limit the scope of the present invention in any way.

### EXAMPLES

### Example 1

### Introduction

Meat treatment compositions according to the invention were tested in meat against a control meat with no additions and a reference meat to which phosphate had been added. The meat product in the tests was a restructured ham. Tests were performed on the preservative effect of the compositions, and on their contribution to the yield and flavor of the meat.

### Experimental Set-Up

The recipes of the meat treatment compositions are presented in Table 1. Dried neutralized vinegar (72 wt. % acetate) was prepared by neutralizing a concentrated vinegar (300 grain, Fleischmann) by adding NaOH until a neutral pH has been reached, and spray drying the concentrated vinegar.

TABLE 1

| | Wt. % | | | |
|---|---|---|---|---|
| | Composition | Composition | Composition | Composition |
| | 1.0 | 2.0 | 2.1 | 2.2 |
| Dried neutralized vinegar | 50 | 48 | 48 | 48 |
| Tomato concentrate ¹ | 10 | 10 | 7 | 5 |
| Citrus fiber ² | 35 | | | |
| Inulin ³ | | 39 | 42 | 44 |
| Acerola juice powder ⁴ | 5 | | | |
| Sodium ascorbate ⁵ | | 3 | 3 | 3 |

¹ SANTE (1.85 wt. % glutamate), ex Lycored
² Herbacel AQ Plus Citrus N01, ex Herbafood
³ Frutatex inulin, ex Sensus
⁴ Acerola juice powder 25% (1078), containing 25 wt. % ascorbate, ex NP Nutra
⁵ Sodium ascorbate, ex Epos

The meat treatment compositions were used in restructured ham products as described in Table 2.

TABLE 2

| | | | Product | Product | Product | Product | Product | Product |
|---|---|---|---|---|---|---|---|---|
| Ingredients | Control | Refer. | 1 | 2 | 3 | 4 | 5 | 6 |
| Ham chunks | 80 | 80 | 80 | 80 | 80 | 80 | 80 | 80 |
| Brine: | | | | | | | | |
| Colorozo Salt | 1.8 | 1.8 | 1.8 | 1.8 | 1.8 | 1.8 | 1.8 | 1.8 |
| Na-ascorbate | 0.05 | 0.05 | | | | | | |
| Phosphate | | 0.1 | | | | | | |
| Dextrose | 0.8 | 0.8 | 0.8 | 0.8 | 0.8 | 0.8 | 0.8 | 0.8 |
| Composition 1.0 | | | 1.0 | 1.2 | 1.4 | | | |
| Composition 2.0 | | | | | | 1.0 | 1.2 | 1.4 |
| Water | 17.35 | 17.25 | 16.4 | 16.2 | 16.0 | 16.4 | 16.2 | 16.0 |
| Total | 100 | 100 | 100 | 100 | 100 | 100 | 100 | 100 |

The compositions were applied to the meat by means of vacuum meat tumbling, applying a green weight marination rate of 25% w/w, meaning that 25% w/w brine was added to 100% w/w meat formulation as shown in Table 2. The brines were prepared by suspending the dry ingredients in water, and cooling the suspension to 0° C. before applying it to meat. The amount of water in the suspensions was adjusted such that a marination rate of 25% w/w was achieved in the meat.

Materials and equipment that were used to make the meat products were as follows:
Tumbler, Type: LU40, LUMAR Ideal Inc., Montreal Canada
Turbovac, Type: SB-420, HFE Vacuum Systems; program 1 for vacuum, program 6 for sealing.
Cooking crimp bags 300*400 mm CN301/CT-1
Cooking: steam cooking cabinet Kerres CS 700
Novasina LabPartner a_{w}, water activity meter
Ham cast type ZM201053, EJ Diest

The meat products were prepared according to the following procedure:
1. Room temperature 10° C.
2. Lean pork meat (topside part); was ground with a 13 mm plate.
3. The ground meat was divided in portions of 850 gram.
4. Brines were prepared at temperature of 0-4° C. The meat treatment compositions were added after salt and dextrose.
5. The ingredients were mixed until fully dispersed.
6. The brine and meat portions were then mixed by hand (with gloves) until homogenously dispersed.
7. The meat mixture was packed subsequently in vacuum bags (at 45 mbar) and then tumbled at 8 rpm per minute at 4° C. for 120 minutes, followed by 30 minutes rest and another 120 minutes of tumbling.
8. The tumbled meat was then stored approximately 18 hours at 0° C. (overnight).
9. The next day, 800 gram of tumbled meat were repacked and vacuumed in cook crimp bag.
10. The bag filled with meat was placed in a ham cast type ZM201053.
11. The samples were cooked in the Kerres cabinet until the internal temperature of 72° C. was reached according to the cooking program shown in Table 3.
12. After the cooking process had finished, the ham casts (with meat inside) were stored at 0° C./32° F.
13. The samples were taken out and evaluated 36 hours later for yield and 7 days later for sensory testing.

TABLE 3

| | | | |
|---|---|---|---|
| Steps | Function Number | Time | Temperature |

| 1 | 5 | (cook) | Chamber | | 75° | C. |
|---|---|---|---|---|---|---|
| 2 | 5 | (cook) | 120 | min. | 75° | C. |
| 3 | 8 | (shower) | 15 | min. | | |
| 4 | 1 | (dry) | 120 | min. | 8° | C. |

### Results and Discussion

TABLE 4

| | pH | | | |
|---|---|---|---|---|
| | brine | after tumbling | finished ham | Yield |
| Control | 7.64 | 5.50 | 5.82 | 76.1 |
| Reference | 7.75 | 5.61 | 5.88 | 87.6 |
| Product 1 | 6.13 | 5.59 | 5.85 | 83.1 |
| Product 3 | 6.10 | 5.63 | 5.88 | 85.1 |
| Product 4 | 6.75 | 5.60 | 5.88 | 84.4 |
| Product 6 | 6.76 | 5.61 | 5.89 | 85.5 |

As shown in Table 4, the cooking yield was significantly higher in the meat products prepared with meat treatment compositions 1.0 and 2.0 as compared to the control meat product. The cooking yield increased with increasing dosage of the meat treatment compositions.

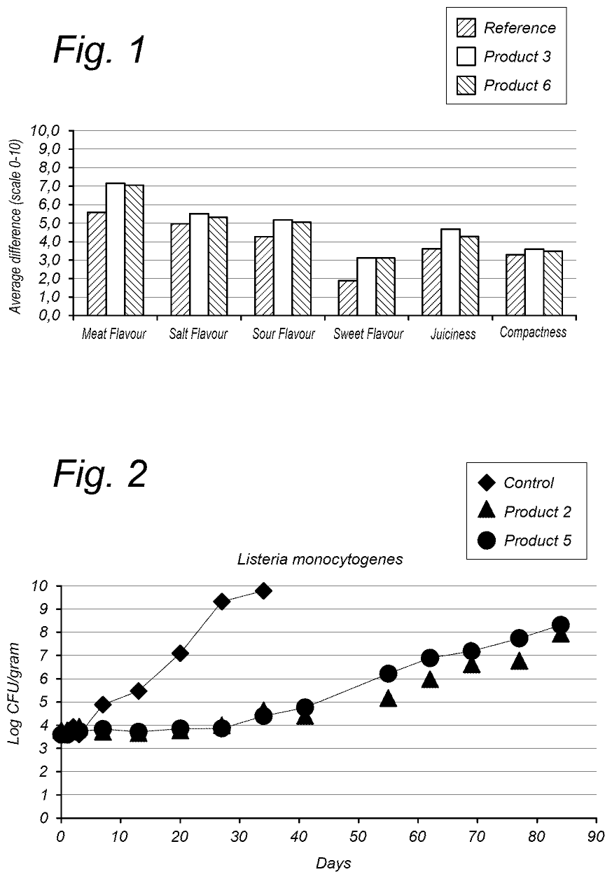

In sensory tests, Products 3 and 6 were compared to the Control product. The flavour and texture were evaluated on the attributes of meatiness, saltiness, sourness, sweetness, juiciness and compactness (FIG. 1). Product 3 and 6 scored better on flavour and texture than the phosphate containing Reference.

A color stability test was performed by visual inspection of the meat during storage. The meat was stored in the fridge at 4° C. and kept in the dark. It became clear that both sodium ascorbate (in Control and Product 6) and acerola (in Product 3) perform equally well with regard to color stability of the meat.

### Example 2

Restructured hams were prepared in the same way as in Example 1, including a control ham and hams that were identical to Products 2 and 5.

FIG. 2 presents the results of a challenge study with Listeria monocytogenes at 4° C. Shelf life is defined as the time at which the microbial counts reach two logs higher than the initial counts. The shelf life for the control meat product was about 20 days. Meat products made with compositions 1.0 and 2.0 (Products 2 and 5, respectively) had a much longer shelf life of from 50 days to 69 days. These results clearly demonstrate the preservative effect of the compositions according to the invention.

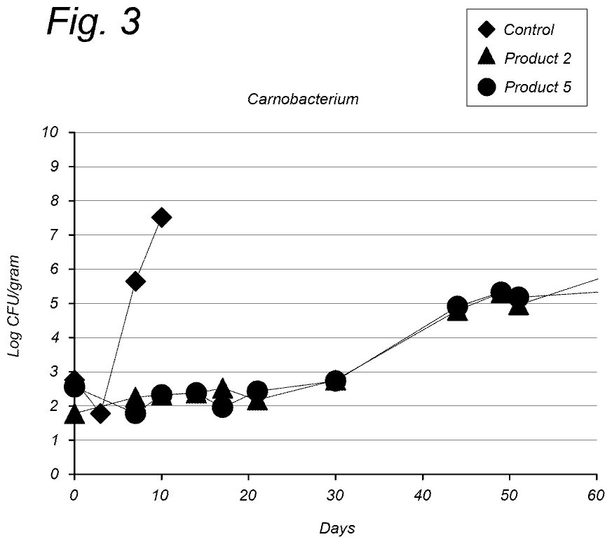

In a challenge study with Carnobacterium at 4° C., the shelf life of the meat product was extended from approximately 9 days for the control meat product to longer than 60 days for Products 2 and 5 (FIG. 3).

### Example 3

Restructured hams were prepared using different meat treatment compositions. The compositions of the meat treatment compositions are shown in Table 5.

TABLE 5

| | Compositon A | Compositon 1 |
|---|---|---|
| Dried neutralized vinegar ¹ | 58.8 | 52.6 |
| Tomato concentrate ¹ | | 10.5 |
| Citrus fiber ¹ | 41.2 | 36.8 |

¹ Same as in Example 1

The restricted hams were prepared as in Example 1 on the basis of the recipes shown in Table 6.

TABLE 6

| Ingredients | Control | Refer. | Product A | Product 1 |
|---|---|---|---|---|
| Ham chunks | 80 | 80 | 80 | 80 |
| Brine: | | | | |
| Colorozo Salt | 1.8 | 1.8 | 1.8 | 1.8 |
| Na-ascorbate | 0.05 | 0.05 | | |
| Phosphate | | 0.1 | | |
| Dextrose | 0.8 | 0.8 | 0.8 | 0.8 |
| Composition A | | | 1.2 | |
| Composition 1 | | | | 1.34 |
| Water | 17.35 | 17.25 | 16.20 | 16.08 |
| Total | 100 | 100 | 100 | 100 |

### Results and Discussion

After overnight storage at 0° C. the color of the products was measured by determining the the L-a-b color values. The results are shown in Table 7.

TABLE 7

| | L* | a* | b* |
|---|---|---|---|
| Control | 64.85 | 14.90 | 7.71 |
| Reference | 67.52 | 13.63 | 7.48 |
| Product A | 65.71 | 13.77 | 8.03 |
| Product 1 | 65.21 | 14.47 | 8.30 |

These results show that the product made with the meat treatment composition of the invention (Product 1) had a more attractive red color than the product that did not contain glutamate (Product A).

### Example 4

Restructured hams were prepared using a meat treatment composition according to the invention. The compositions of the meat treatment is shown in Table 8.

TABLE 8

| | Compositon 1 |
|---|---|
| Dried neutralized vinegar ¹ | 52.6 |
| Tomato concentrate ¹ | 10.5 |
| Inulin ¹ | 36.8 |

² Same as in Example 1

The restricted hams were prepared as in Example 1 on the basis of the recipes shown in Table 9.

TABLE 9

| | Wt % | | |
|---|---|---|---|
| Ingredients | Control | Refer. | Product 1 |
| Ham chunks | 80 | 80 | 80 |
| Brine: | | | |
| Colorozo Salt | 1.8 | 1.8 | 1.8 |
| Na-ascorbate | 0.05 | 0.05 | |
| Phosphate | | 0.1 | |
| Dextrose | 0.8 | 0.8 | 0.8 |
| Composition 1 | | | 1.34 |
| Water | 17.35 | 17.25 | 16.08 |
| Total | 100 | 100 | 100 |

### Results and Discussion

TABLE 10

| | pH | | | |
|---|---|---|---|---|
| | brine | after tumbling | finished ham | Yield |
| Control | 7.69 | 5.79 | 6.06 | 75.13 |
| Reference | 7.91 | 5.86 | 6.13 | 94.83 |
| Product 1 | 6.29 | 5.82 | 6.11 | 82.64 |

1. A composition for maintaining or improving the quality of processed meat, comprising, on a dry matter basis:
(a) between 20 and 60% w/w acid equivalent of an organic acid component selected from the group of acetate, lactate and combinations thereof;
(b) between 0.02 and 2% w/w acid equivalent of glutamate; and
(c) between 5 and 50% w/w of a vegetal fiber selected from the group of microfibrillated cellulose fiber, inulin and combinations thereof,
wherein the composition when diluted with distilled water of 20° C. to a dry matter content of 10% w/w has a pH in the range of 5.0 to 9.0.

2. The composition according to claim 1, wherein the composition is a powder having a water content of less than 15% w/w; wherein the organic acid component is selected from sodium acetate, sodium lactate, potassium acetate, potassium lactate, calcium acetate, calcium lactate, acetic acid, lactic acid and combinations thereof; and
wherein the glutamate is selected from sodium glutamate, potassium glutamate, glutamic acid and combinations thereof.

3. The composition according to claim 1, wherein the composition is an aqueous liquid having a dry matter content of 10 to 80% w/w.

4. The composition according to claim 2, wherein the inulin has an average degree of polymerization of at least 15 monomers.

5. The composition according to claim 4, wherein the inulin has an average degree of polymerization of at least 20 monomers.

6. The composition according to claim 1, comprising on a dry matter basis between 25 and 55% w/w acid equivalent of acetate and/or lactate.

7. The composition according to claim 6, comprising on a dry matter basis between 30 and 50% w/w, acid equivalent of acetate and/or lactate.

8. The composition according to claim 1, comprising on a dry matter basis between 0.04 and 1.5% w/w acid equivalent of glutamate.

9. The composition according to claim 8, comprising on a dry matter basis between 0.06 and 1% w/w, acid equivalent of glutamate.

10. The composition according to claim 1, comprising on a dry matter basis between 7 and 45% w/w of the vegetal fiber.

11. The composition according to claim 10, comprising on a dry matter basis between 8 and 42% w/w, of the vegetal fiber.

12. The composition according to claim 1, wherein the aqueous composition obtained by dispersing 10% w/w of the composition into distilled water of 20° C. has a pH in the range of 5.5 to 8.5.

13. The composition according to claim 12, wherein the aqueous composition obtained by dispersing 10% w/w of the composition into distilled water of 20° C. has a pH in the range of 5.8 to 8.0

14. The composition according to claim 1, additionally comprising on a dry matter basis between 0.5 and 5% w/w acid equivalent of ascorbate.

15. The composition according to claim 14, comprising on a dry matter basis between 1.0 and 4% w/w acid equivalent of ascorbate.

16. A method for the preparation of a composition for maintaining or improving the quality of processed meat, comprising:
(a) providing an organic acid product selected from the group of a vinegar product, a lactic acid fermentation product and combinations thereof, containing on a dry weight basis at least 50% w/w acid equivalent of acetate and/or lactate, wherein the acetate is selected from sodium acetate, potassium acetate, calcium acetate, acetic acid and combinations thereof and wherein the lactate is selected from sodium lactate, potassium lactate, calcium lactate, lactic acid and combinations thereof,
(b) providing a tomato extract containing on a dry weight basis at least 1.0% w/w acid equivalent of glutamate, wherein the glutamate is present as a component selected from sodium glutamate, potassium glutamate, glutamic acid and combinations thereof,
(c) providing a vegetal fiber selected from the group of citrus fiber and inulin;
(d) mixing the organic acid product, the tomato extract and the vegetal fiber to prepare a composition with a dry matter content of at least 30% w/w.

17. The method according to claim 16, comprising mixing the organic acid product, the tomato extract and the vegetal fiber to prepare a composition with a dry matter content of at least 50% w/w.

18. The method according to claim 16, wherein the method comprises mixing the vinegar product and/or lactic acid fermentation product, the tomato extract and the vegetable fiber with a fruit extract containing on a dry weight basis at least 10% w/w ascorbate.

19. A process of preparing processed meat, comprising adding the composition according to claim 1 to meat in an amount of between 0.5 and 15% w/w dry matter.

20. The process according to claim 20, comprising adding the composition in an amount of between 1.0 and 10% w/w dry matter.

21. The process according to claim 20, wherein the composition is an aqueous liquid and wherein the composition is added by injection tumbling.
